(19) United States
(12) Patent Application Publication
(10) Pub. No.: US 2025/0203125 A1
(43) Pub. Date: Jun. 19, 2025

(54) DYNAMIC CACHE ALLOCATION FOR DISPLAY PIXEL DATA CACHING

(71) Applicant: Intel Corporation, Santa Clara, CA (US)

(72) Inventors: Ankit Mukeshkumar Shah, El Dorado Hills, CA (US); Geethacharan Rajagopalan, Gold River, CA (US); Partha Robert Choudhury, Portland, OR (US); Erik Hallnor, Beaverton, OR (US)

(73) Assignee: Intel Corporation, Santa Clara, CA (US)

(21) Appl. No.: 19/067,299

(22) Filed: Feb. 28, 2025

(51) Int. Cl. H04N 21/2183; H04N 19/182

(52) U.S. Cl. CPC H04N 21/2183; H04N 19/182

(57) ABSTRACT

Systems, apparatus, articles of manufacture, and methods to implement dynamic cache allocation for display pixel data caching are disclosed. An example apparatus disclosed herein compresses pixel data fetched from memory to determine compressed pixel data associated with a first frame to be displayed by a display device. The disclosed example apparatus also writes at least a portion of the compressed pixel data to a cache based on an amount of the cache allocated to display buffering, the cache different from the memory. The disclosed example apparatus further generates a second frame based on the at least the portion of the compressed pixel data in the cache, the second frame to be displayed by the display device after the first frame.

### BACKGROUND

Display devices(s), such as internal and/or external display panel(s), and the display subsystem driving the display device(s) are some of the dominant active components of a compute system when the compute system is an active or ON state. The display subsystem of a compute system is responsible for fetching the frame data (e.g., pixel data) from system memory, and providing the frame data to the display device(s). In some compute systems, the display subsystem is one of the largest consumers of system memory bandwidth. This is because the display subsystem in such a compute system keeps the memory subsystem of the compute system active by fetching frame data at regular intervals to refresh the display device(s) at a configured refresh rate even if the frame content being displayed is unchanged. As a result, the display subsystem can have substantial impact on battery life and thermal behavior of the compute system.

### BRIEF DESCRIPTION OF THE DRAWINGS

FIG. 1 is a block diagram of an example system that includes example frame replay circuitry and example cache management circuitry to implement dynamic cache allocation for display pixel data caching in accordance with teachings of this disclosure.

FIG. 2 illustrates an example operation of the frame replay circuitry to generate replayed frames based on cached pixel data.

FIG. 3 is a block diagram of an example implementation of the frame replay circuitry of FIG. 1.

FIG. 4 is a block diagram of an example implementation of the cache management circuitry of FIG. 1.

FIGS. 5-6 illustrate example dynamic cache allocation and associated display pixel caching scenarios supported by the frame replay circuitry of FIGS. 1 and/or 3, and the cache management circuitry of FIGS. 1 and/or 4.

FIGS. 7-8 are flowcharts representative of example machine-readable instructions and/or example operations that may be executed, instantiated, and/or performed by example programmable circuitry to implement the frame replay circuitry of FIGS. 1 and/or 3.

FIG. 9 is a flowchart representative of example machine-readable instructions and/or example operations that may be executed, instantiated, and/or performed by example programmable circuitry to implement the cache management circuitry of FIGS. 1 and/or 4.

FIG. 10 is a block diagram of an example processing platform including programmable circuitry structured to execute, instantiate, and/or perform the example machine-readable instructions and/or perform the example operations of FIGS. 7-9 to implement the frame replay circuitry and the cache management circuitry of FIGS. 3 and 4.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Example systems, apparatus, methods and articles of manufacture (e.g., non-transitory computer-readable storage media) that implement techniques to perform dynamic cache allocation for display pixel data caching are disclosed herein. Some such example techniques are able to reduce the impact of a display subsystem on system memory bandwidth and activity, thereby reducing power consumption, increasing battery life and/or improving the thermal behavior of a compute system. Some disclosed example techniques implement an architecture to write pixel data associated with a previously displayed frame to a system cache and to use the cached pixel data to generate subsequent frames to be displayed by a display device when the displayed frame content is unchanged (e.g., when no frame updates have occurred for the subsequent frames). In some examples, use of the system cache in this manner allows the display subsystem to limit system memory accesses to times at which new frames corresponding to frame updates are to be read from memory. Such a reduction in memory access events can substantially reduce the system memory bandwidth utilized by the display subsystem and allow the system memory to remain in a low power state for longer periods of times, thereby providing substantial power savings.

Some example techniques disclosed herein implement compression and/or a dynamic workload-aware cache allocation procedure to enhance utilization of the system cache for display pixel data caching. For example, the pixel data associated with a previously displayed frame may be compressed before writing the data to the system cache. The use of compression can increase the likelihood that an entire frame's worth of compressed pixel data will fit in the system cache. Additionally or alternatively, in compute systems having system caches that are shared among multiple caching agents, the dynamic workload-aware cache allocation procedure can increase the amount of the system cache allocated to display data buffering, which can increase the likelihood that an entire frame's worth of compressed pixel data will fit in the system cache, especially during system idle times when the displayed frame content is likely to remain unchanged.

Other approaches that attempt to reduce display subsystem utilization of system memory include employing display devices with panel self-refresh (PSR) capability and/or adding dedicated local frame buffers to the compute system for buffering frame data to be replayed when the displayed frame content is unchanged. However, PSR-enabled display devices can be expensive due to the inclusion of large PSR frame buffers in the devices, and dedicated local frame buffers can increase the cost and die area of the compute system. For example, frame buffers capable of buffering a 3840×2160 4K frame at 4 bytes per pixel may be 31.65 megabytes (MB) or larger. In contrast, example techniques disclosed herein enable efficient utilization of an existing, smaller system cache (e.g., having a size of 8 MB or some other size) for display pixel data caching without incurring the extra cost of PSR-enabled displays or local frame buffers.

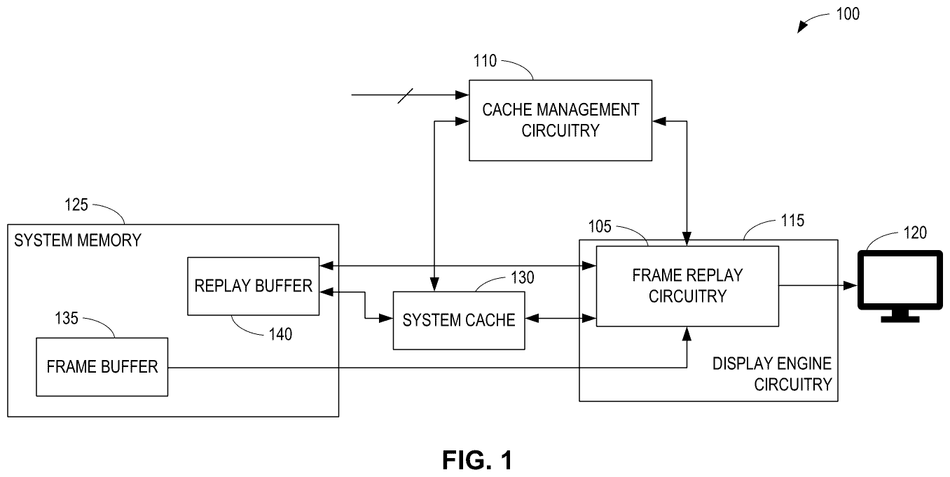

FIG. 1 is a block diagram of an example compute system 100 that includes example frame replay circuitry 105 and example cache management circuitry 110 to implement dynamic cache allocation for display pixel data caching in accordance with teachings of this disclosure. The compute system 100 of the illustrated example also includes an example display subsystem 115, which is illustrated as example display engine circuitry 115, coupled to one or more example display devices 120. The compute system 100 of the illustrated example further includes example system memory 125 and an example system cache 130.

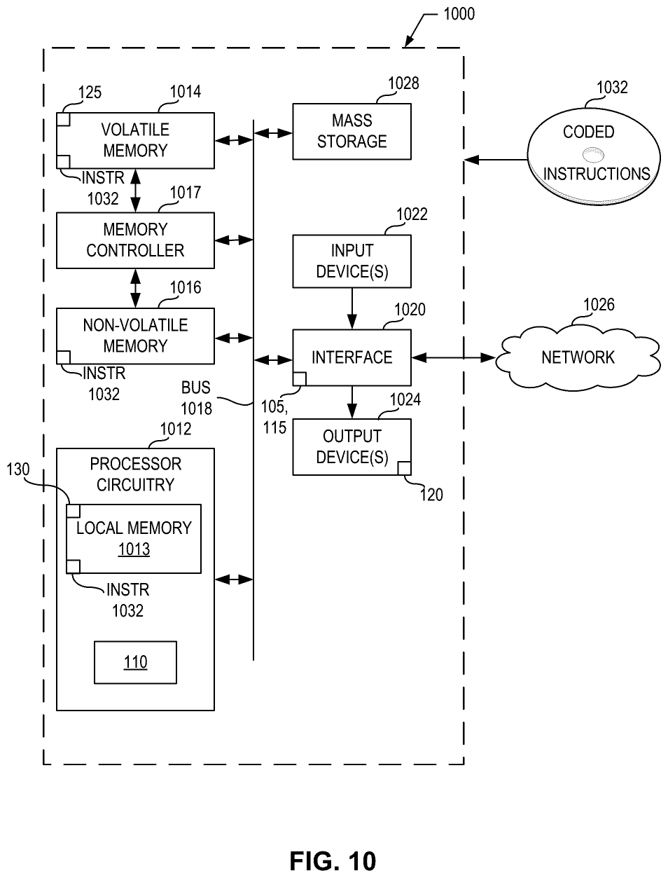

In the illustrated example, the display engine circuitry 115 reads displayable frames, also referred to as frames, from one or more example frame buffers 135 allocated in the system memory 125. In some examples, the system memory 125 of the compute system 100 is implemented by one or more memories, memory devices, storage devices, etc. For example, the system memory 125 can be implemented by the main memory 1014 of FIG. 10, which is described in further detail below. In some examples, the frames stored in the frame buffer 135 include pixel data rendered by one or more rendering agents, such as a streaming application, a game application, a conferencing application, an office productivity application, etc., executed by the compute system 100. The display engine circuitry 115 of the illustrated example also processes the retrieved frames and provides (e.g., streams) the frame data to the display device 120 for presentation. In some examples, the display engine circuitry 115 transmits successive frames of pixel data to the display device 120 at a configured refresh rate, such as 60 Hertz (Hz) or some higher or lower refresh rate. However, accessing frames of pixel data from the frame buffer 135 at that refresh rate would involve frequent system memory activity and constant bandwidth utilization, which would result in substantial power consumption.

Fortunately, the frame content may change at a lower rate than the refresh rate. For example, the frame content may remain unchanged for rather long periods of time, such as while text displayed by the display device 120 is being read by a user, a presentation slide is being displayed by the display device 120 during a teleconference, a video being displayed by the display device 120 is paused, a static desktop background is being displayed, etc. To reduce the rate of system memory access and, thus, reduce memory bandwidth utilization, the display engine circuitry 115 includes the frame replay circuitry 105 to take advantage of such unchanged display content by caching and replaying a previously displayed frame until a frame update occurs and a new frame with new frame content is saved in the frame buffer 135. Reducing the rate at which the system memory 125 is accessed to read frame data from the frame buffer 135 enables the system memory 125 to enter a low power state, such as an idle state, more frequently, thereby reducing power consumption relative to approaches that involve accessing the system memory 125 at the display device refresh rate.

As noted above, other approaches that attempt to reduce display subsystem utilization of system memory include employing display devices with PSR capability and/or adding dedicated local frame buffers to the compute system for buffering frame data to be replayed when the displayed frame content is unchanged. However, PSR-capable display devices (e.g., display panels) can be expensive to build because the PSR-capable display device utilizes large internal frame buffer(s) to store and refresh screen content. Likewise, adding large frame buffer(s) to the compute system itself for storing and refreshing screen content is similarly costly.

In contrast, the display engine circuitry 115 includes the frame replay circuitry 105 to utilize the system cache 130 to cache screen content, such as a previously displayed frame, for replay by the display device 120 when there are no frame updates and, thus, the displayed frame content is unchanged. In some examples, the system cache 130 is implemented by one or more cache memories. In some examples, the system cache 130 may already be included in the compute system 100 to cache data from other caching agents and, thus, using the system cache 130 to cache display frame data may have negligible impact on the bill-of-material (BOM) cost of the compute system 110. However, the size of the system cache 130 may be smaller than that of a frame buffer (such as a system cache size of 8 MB) and, thus, may be unable to fit an entire frame of pixel data to be displayed by the display device 120. As a result, caching raw frame buffer pixel data could lead to cache thrashing that would evict the cached data associated with other caching agents that utilize the system cache 130, and/or could lead to self-eviction of existing cached pixel data as pixel data later in the frame overwrites pixel data cached earlier in the frame. Such cache thrashing and self-eviction can negatively impact overall system performance.

To enable efficient use of the system cache 130, the frame replay circuitry 105 performs inline compression of the pixel data fetched from the frame buffer 135 for a new frame (e.g., responsive to a frame update) and, based on the level of compression achieved, writes at least a portion of the compressed pixel data to the system cache 130. For example, if the level of compression is sufficient for the entire frame's worth of compressed pixel data to fit in an amount of the system cache 130 allocated to the display engine circuitry 115 for display data buffering, then the frame replay circuitry 105 can store all the compressed pixel data for the current frame in the system cache 130. However, if the entire frame's worth of compressed pixel data does not fit into the allocated amount of the system cache 130, then the frame replay circuitry 105 can write a first portion of the compressed pixel data to the system cache 130 (e.g., with the first portion selected to fit in the allocated amount of the system cache 130) and write a remaining second portion of the compressed pixel data to an example replay buffer 140 reserved in the system memory 125. For example, the replay buffer 140 may be located at a starting, fixed address of the system memory 125. In either scenario, the compressed pixel data written to the system cache 130 and/or the replay buffer 140 is later fetched by the frame replay circuitry 105 and uncompressed to generate subsequent frame(s) for replay by the display device 120 if those frame(s) are unchanged relative to the most recent new frame (e.g., if no frame update(s) occurred for those subsequent frame(s)). The use of such compression reduces bandwidth utilization by reducing the number of accesses to the system memory 125 for replays of a frame.

Thus, the frame replay circuitry 105 of the display engine circuitry 115 enables effective caching of the compressed frame pixel data into the system cache 130. In some examples, the frame replay circuitry 105 limits the amount of compressed pixel data caching to fit in an amount of the system cache 130 allocated for use by the display engine circuitry 115 for display data buffering. For example, for a given frame of pixel data fetched from the frame buffer 135, the frame replay circuitry 105 may compress the fetched pixel data and then tag the corresponding compressed pixel data write requests and display read requests for allocation to the system cache 130 until an allocation limit is reached (e.g., as provided by the cache management circuitry 110, which is described in further detail below). In some such example, any remaining compressed pixel data write requests and display read requests are tagged by the frame replay circuitry 105 for allocation to the replay buffer 140 in the system memory 125. Such operation can reduce or eliminate cache thrashing and improve the likelihood of cache hits during the next frame read.

In the illustrated example of FIG. 1, the cache management circuitry 110 further enables effective caching of the compressed frame pixel data into the system cache 130 by dynamically managing allocation of the system cache 130 for display data buffering. For example, the cache management circuitry 110 dynamically adjusts the amount of the system cache 130 allocated to the display subsystem 115 for pixel data buffering based on the activity (e.g., power state(s)) of other cache accessing agent(s) in the compute system 100.

For example, cache accessing agents other than the display subsystem 115 may be idle while the display subsystem 115 is actively providing frames to the display device 120 for display. In such examples, the cache management circuitry 110 can increase the amount of the system cache 130 allocated for display data buffering, thereby increasing the amount of frame pixel data that can be written by the frame replay circuitry 105 to the system cache 130. In this way, the cache management circuitry 110 can adapt cache allocation to favor the display subsystem 115 during system idle scenarios when other cache accessing agents, such as one or more central processing unit (CPU) cores of the compute system 100, are not busy without degrading overall system performance. Furthermore, in scenarios in which the frame replay circuitry 105 is able to achieve a sufficient data compression ratio, the frame of compressed pixel data may fully fit into the system cache 130, allowing the entire system memory 125 to enter and stay in deeper low power states for a longer periods of time, thereby resulting in substantial power savings.

In the illustrated example of FIG. 1, the cache management circuitry 110 can implement any cache allocation algorithm or combination of algorithms to allocate regions of the system cache 130 to different cache accessing agents, including but not limited to the display subsystem 115. For example, the cache management circuitry 110 can define a reserved area of the system cache 130 and allocate different regions of the reserved area to a first, higher priority group of cache accessing agents, and allocate other regions, as available, of the remaining unreserved are of the system cache 130 to a second, lower priority group of cache accessing agents. In some such examples, the cache management circuitry 110 includes the display subsystem 115 in the first, higher priority group of cache accessing agents, to ensure that at least some amount of the system cache 130 can be allocated to display data buffering.

In some examples, the cache management circuitry 110 dynamically updates the amount of the system cache 130 allocated to the display subsystem 115 for display data buffering based on measured activity of the compute system 100. For example, the cache management circuitry 110 may monitor the different cache accessing agents that are able to access the system cache 130, including the display subsystem 115, to determine their respective activity states (e.g., active, idle, etc.). In such examples, any appropriate monitoring technique or combination of techniques can be used by the cache management circuitry 110 to monitor the cache accessing agent(s) that are able to access the system cache 130. For example, the cache management circuitry 110 can utilize information from power management circuitry included in the compute system 100 to track the power state(s) and/or any other activity state(s) of the cache accessing agent(s).

In some such examples, the cache management circuitry 110 may use the measured activity states to allocate regions of the system cache 130 to different ones of the cache accessing agents, including the display subsystem 115. For example, the cache management circuitry 110 may use heuristic rules based on post-silicon tuning to evaluate the combination of measured activity states and allocate the system cache 130 accordingly. In some examples, the cache management circuitry 110 may utilize one or more trained machine learning models to process the combination of measured activity states to allocate the system cache 130 to the cache accessing agents, including the display subsystem 115.

By way of example, consider a scenario based on an idle display ON workload in which a user of the compute system 100 is involved in activity resulting in no frame updates for a period of time, such as when reading an open document displayed by the display device 120. In such a scenario, a goal of display pixel data caching, as disclosed herein, is to quiesce the system memory 125 to enable deeper low power states and have the system cache 130 provide the pixel data for replayed frames to be displayed by the display device 120. In some such examples, the cache management circuitry 110 measures the activity states of the different circuit elements of the compute system 100 and attempts to allocate a sufficient amount of the system cache 130 to fit an entire frame's worth of compressed pixel data. By caching an entire frame's worth of compressed pixel data, writes to and reads from the replay buffer 140 can be avoided, enabling the system memory 125 to enter a low power state for longer periods of time.

Table 1 below lists some prevalent panel resolutions. Assuming the frame replay circuitry 105 achieves an average compression ratio of 6:1 for the example idle workload scenario under analysis, and the frame has standard dynamic range (SDR), Table 1 shows that the compressed frame size remains below 6 MB, which is able to fit in a system cache 130 having a size of 8 MB. Thus, in a compute system 100 with a system cache 130 having a size of 8 MB, based on system idleness and workload, the cache allocation by the cache management circuitry 110 to display data buffering may result in all frame replay accesses from the system cache 130, thereby mimicking PSR behavior without utilizing a PSR-enabled display device. Furthermore, in a compute system 100 with a system cache 130 exceeding a size of 8 MB, the power saving benefits can scale to accommodate higher frame resolutions, such as high dynamic range (HDR) frames. Although an average compression ratio of 6:1 is assumed for this example idle workload scenario, the average compression ratio can be better or worse in other examples depending on the difference between adjacent pixels in the particular frame of interest.

TABLE 1

| | | Compressed | Amount of |
|---|---|---|---|
| | | Pixel Data Size | Compressed Pixel Data |
| | | for a Standard | able to be Allocated |
| Single Plane | | Dynamic | to the System Cache |
| RGB Display | Compression | Range Frame | (assuming 6 MB allocated |
| Resolution | Ratio | (4 bytes/pixel) | to the display subsystem) |
| 1920 × 1080 | 6 | 1.32 MB | 100% for replays |
| 2560 × 1440 | 6 | 2.35 MB | 100% for replays |
| 2880 × 1880 | 6 | 3.45 MB | 100% for replays |
| 3840 × 2160 | 6 | 5.28 MB | 100% for replays |

In some examples, the cache management circuitry 110 treats the display subsystem 115 as a caching agent to the system cache 130 for both writes and reads of compressed pixel data, with appropriate hooks available to configure pixel data caching behavior. In some examples, the frame replay circuitry 105 of the display subsystem 115 implements an intelligent tagging mechanism that identifies, based on a current amount of the system cache 130 allocated to the display subsystem 115, which compressed pixel data is to be written to the system cache 130 and which compressed pixel data is to be written to the replay buffer 140 in the system memory 125. As the cache management circuitry 110 dynamically updates the amount of the system cache 130 allocate to the display subsystem 115 for display data caching, the intelligent tagging mechanism of the frame replay circuitry 105 varies the amount of a frame's compressed pixel data that is tagged for writing to the system cache 130 and the remaining amount of the frame's compressed pixel data that is tagged for writing to the replay buffer 140 in the system memory 125

In some examples, when the content displayed by the display device 120 is not idle and, thus, the frames to be displayed are associated with frame updates, the display subsystem 115 retrieves the frames from the frame buffer 135 of the system memory 125 at a frame update rate, which may be the display refresh rate. In some such examples, the display subsystem 115 does not use pixel data written to the system cache 130 to generate the frames to be displayed by the display device 120 (e.g., because each frame is a new frame containing updated frame content). This, in some such scenarios, the cache management circuitry 110 can reduce the amount of the system cache 130 allocated to the display subsystem 115 for display data buffering (e.g., to 2 MB or some other value, or even disable caching of compressed pixel data) and increase the amount(s) of the system cache 130 allocated to other cache accessing agent(s) in the compute system 100.

In some examples, the cache management circuitry 110 of the compute system 100 is implemented by or included in circuitry that has system-wide access to the different circuit elements, agents, etc., of the compute system 100. For example, the cache management circuitry 110 may be implemented by or otherwise included in power management circuitry of the compute system 100. In some examples, the cache management circuitry 110 may be implemented by software, such as micro-code instructions, executed by the power management circuitry of the compute system 100 to measure the activity states of the different circuit elements, agents, etc., of the compute system 100 and perform cache allocation accordingly,

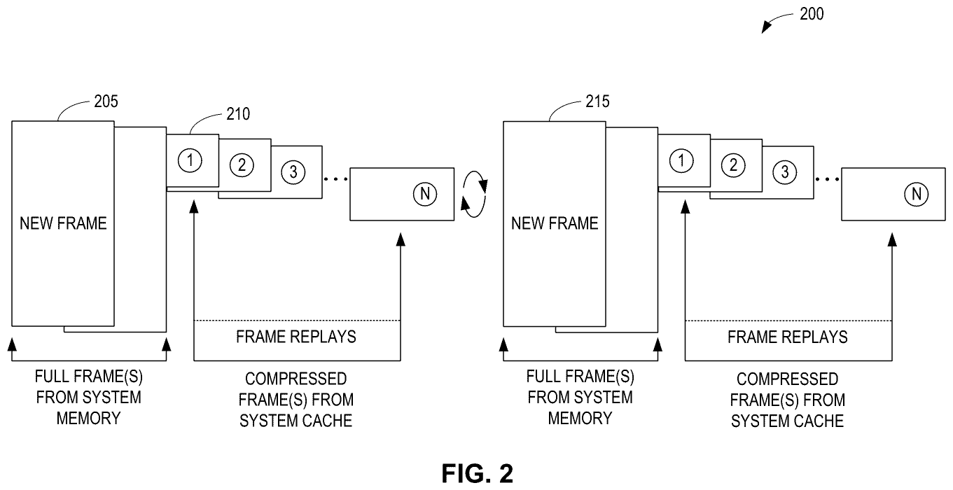

FIG. 2 illustrates example operations 200 performed by the frame replay circuitry 105 of FIG. 1 to generate replayed frames based on cached pixel data. The example operations 200 of FIG. 2 begin with the frame replay circuitry 105 fetching new frame(s) 205 from the frame buffer 135 of the system memory 125. The new frame(s) 205 are associated with frame updates, which indicate the new frame(s) 205 contain new (e.g., updated) content to be displayed by the display device 120. As described above, when the frame replay circuitry 105 fetches a given frame from the frame buffer 135, the frame replay circuitry 105 compresses the fetched frame pixel data and writes the compressed pixel data for the frame (or at least a portion thereof) to the system cache 130. In the illustrated example of FIG. 2, it is assumed that an entire frame's worth of compressed pixel data fits in the system cache 130.

Next, a subsequent set of one or more frames 210 are not associated with frame updates and, thus, contain unchanged content. As a result, the frame replay circuitry 105 reads the cached, compressed pixel data from the system cache 130 to generate the set of frame(s) 210, as described above, for display by the display device 120. In some examples, the frame replay circuitry 105 reads the cached, compressed pixel data from the system cache 130 to generate the set of frame(s) 210 without retrieving/fetching the pixel data from the system memory 125 a second time. In the example operations 200 of FIG. 2, the frame replay circuitry 105 continues generating the frame(s) 210 from the same cached, compressed pixel data until a new frame 215 associated with a frame update is available in the frame buffer 135 of the system memory 125. The example operations 200 then repeat.

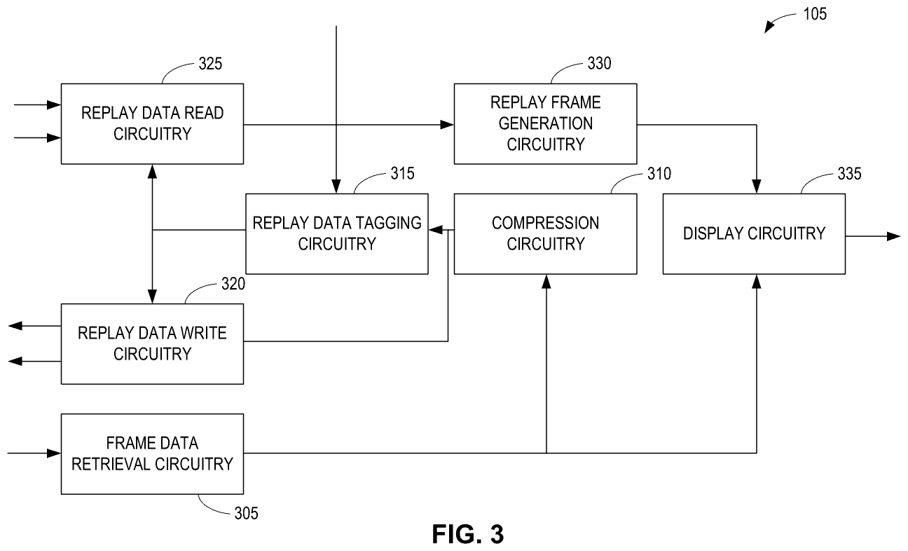

FIG. 3 is a block diagram of an example implementation of the frame replay circuitry 105 of FIG. 1. The frame replay circuitry 105 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the frame replay circuitry 105 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example frame replay circuitry 105 of FIG. 3 includes example frame data retrieval circuitry 305, example compression circuitry 310, example replay data tagging circuitry 315, example replay data write circuitry 320, example replay data read circuitry 325, example replay frame generation circuitry 330 and example display interface circuitry 335. In the illustrated example, the frame data retrieval circuitry 305 retrieves new frames from the frame buffer 135 in system memory 125 (see FIG. 1). For example, if the frame data retrieval circuitry 305 detects a frame update for a next frame to be displayed by the display device 120 (see FIG. 1), the frame data retrieval circuitry 305 retrieves the frame data, such as the frame's pixel data, for that frame from the frame buffer 135 in system memory 125. This is because the frame update indicates that the content of the next frame has changed from the preceding frame and, thus, the next frame is a new frame to be retrieved from the frame buffer 135 in system memory 125.

The compression circuitry 310 of the illustrated example compresses the frame data, such as the pixel data, of the new frame retrieved by the frame data retrieval circuitry 305 to determine compressed frame data, such as compressed pixel data, associated with the retrieved new frame. The compression circuitry 310 can implement any appropriate compression algorithm or combination of algorithms, such as one or more lossless compression algorithms, one or more lossy compression algorithms, etc., to compress the original frame data (e.g., pixel data) to yield compressed frame data (e.g., compressed pixel data) that has a smaller size than the original data. For example, the compression circuitry 310 may implement compression algorithm(s) designed to achieve compression ratios of 6, or some other value, to achieve a six-fold reduction (or some other reduction) in the size of the compressed data relative to the original data. As described above, the compressed frame data, such as compressed pixel data, associated with the retrieved new frame can be used to generate subsequent replayed frame(s) if the displayed frame content becomes idle (e.g., unchanged) such that there are no frame update(s) for those subsequent frame(s).

The replay data tagging circuitry 315 of the illustrated example allocates the compressed frame data, such as compressed pixel data, determined by the compression circuitry 310 for the retrieved new frame for storage in the system cache 130, or for storage in a combination of the system cache 130 and the replay buffer 140 in the system memory 125 (see FIG. 1). For example, the determines an amount of the system cache 130 that has allocated by the cache management circuitry 110 to the display subsystem 115 for display data buffering. In some examples, the replay data tagging circuitry 315 obtains information from the cache management circuitry 110 that specifies the amount of the system cache 130 allocated to display buffering at the present time. As described above, the amount of the system cache 130 allocated to display buffering is variable (e.g., updateable by the cache management circuitry 110 based on measured activity state(s) in the compute system 100 of FIG. 1). As such, in some examples, the replay data tagging circuitry 315 accesses the information specifying the amount of the system cache 130 allocated to display buffering prior to allocating the compressed frame data, such as compressed pixel data, for storage to ensure the replay data tagging circuitry 315 is using the latest cache allocation determined by the cache management circuitry 110.

In some examples, the information provided by the cache management circuitry 110 specifies a region of the system cache 130 that is allocated to display buffering. In some such examples, the replay data tagging circuitry 315 uses the allocated cache region's specifications to calculate an amount of the system cache 130 allocated at the present time to the display subsystem 115 for display data buffering. Based on the amount of the system cache 130 allocated for display data buffering, the replay data tagging circuitry 315 allocates at least a portion of the compressed frame data, such as compressed pixel data, associated with the retrieved new frame for storage in the system cache 130. In some examples, the replay data tagging circuitry 315 may determine that the total amount of the compressed frame data, such as compressed pixel data, associated with the retrieved new frame will fit into the allocated amount of the system cache 130. In such examples, the replay data tagging circuitry 315 may select the total amount of the compressed frame data, such as compressed pixel data, associated with the retrieved new frame for storage in the system cache 130. However, in some examples the replay data tagging circuitry 315 may determine that the total amount of the compressed frame data, such as compressed pixel data, associated with the retrieved new frame will not fit into the allocated amount of the system cache 130. In such examples, the replay data tagging circuitry 315 may select a first portion of the compressed frame data, such as compressed pixel data, associated with the retrieved new frame for storage in the system cache 130, with the first portion of the data selected to fit in the system cache 130. In such examples, the replay data tagging circuitry 315 may select a remaining second portion of the compressed frame data, such as compressed pixel data, associated with the retrieved new frame for storage in the replay buffer 140 of the system memory 125.

In some examples, the replay data tagging circuitry 315 assigns a first tag to the compressed frame data, such as compressed pixel data, selected for storage in the system cache 130, and assigns a second tag to any remaining compressed frame data, such as compressed pixel data, selected for storage in the system cache 130 in the replay buffer 140 reserved in the system memory 125. For example, the first tag may have a first value to identify data that is cacheable and, thus, is allocated for storage in the system cache 130, and the second tag may have a second value to identify data that is not cacheable and, thus, is allocated for storage in the replay buffer 140. Thus, in the preceding example, the replay data tagging circuitry 315 may assigns the first tag to the first portion of the compressed frame data, such as compressed pixel data, selected for storage in the system cache 130, and may assign the second tag to the remaining second portion of the compressed frame data, such as compressed pixel data, selected for storage in the replay buffer 140 reserved in the system memory 125.

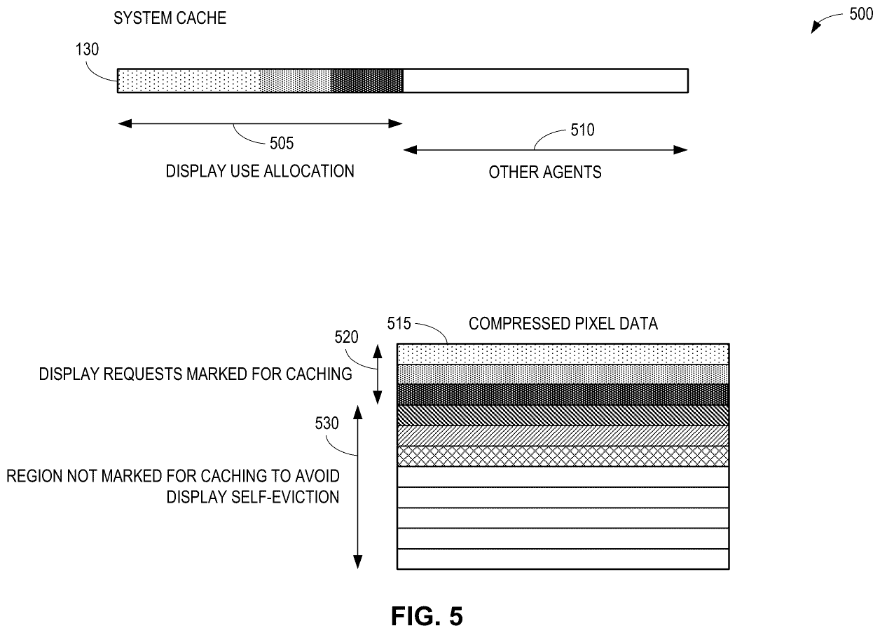

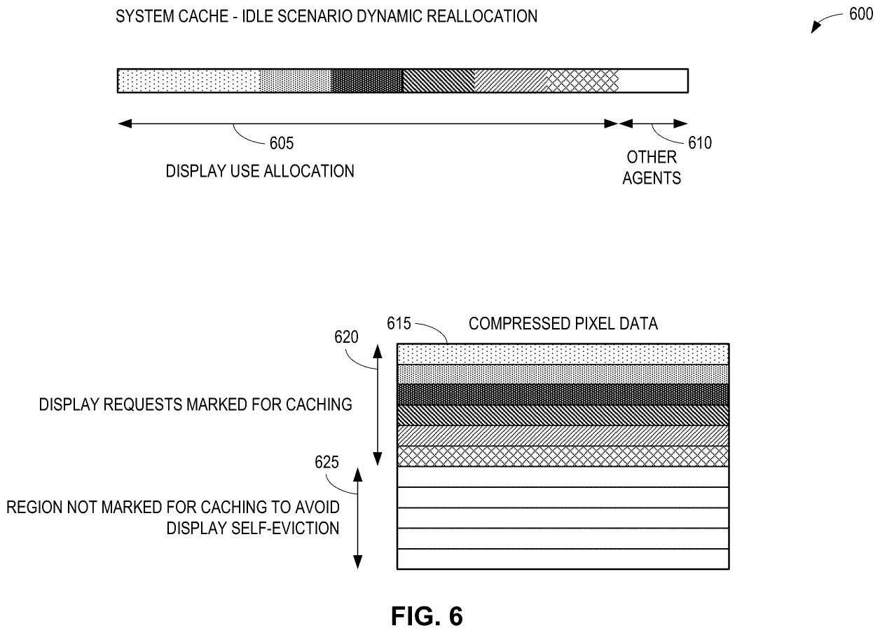

In some examples, the replay data tagging circuitry 315 utilizes a data structure to assign the first tag to the compressed frame data, such as compressed pixel data, selected for storage in the system cache 130, and to assigns the second tag to any remaining compressed frame data, such as compressed pixel data, selected for storage in the system cache 130 in the replay buffer 140 reserved in the system memory 125. For example, the replay data tagging circuitry 315 may use the data structure to identify where to write the compressed frame data, such as compressed pixel data, associated with the retrieved new frame, and where to read that data from in the event a replay frame is to be generated for a subsequent frame. In some examples, the replay data tagging circuitry 315 tags the compressed frame data, such as compressed pixel data, associated with the retrieved new frame at the resolution based on the amount of data included in the write instructions used to write data to the system cache 130 and/or the amount of data returned by the read instructions used to read data from the system cache 130. For example, the replay data tagging circuitry 315 may tag the compressed frame data, such as compressed pixel data, associated with the retrieved new frame, at a resolution of a cache line such that each cache line of compressed frame data, such as compressed pixel data, is tagged with a respective tag. Further details concerning operation of the replay data tagging circuitry 315 are provided below in the context of the description of FIGS. 5 and 6.

The replay data write circuitry 320 of the illustrated example writes the compressed frame data, such as compressed pixel data, determined the compression circuitry 310 for a retrieved new frame to the system cache 130, or a combination of the system cache 130 the replay buffer 140 reserved in the system memory 125, based on an amount of the system cache 130 allocated for display data buffering. In other words, the replay data write circuitry 320 writes at least a portion of the compressed frame data, such as compressed pixel data, associated with the retrieved new frame to the system cache 130 based on the amount of the system cache 130 allocated for display data buffering, also referred to as display buffering, frame buffering, etc. Thus, in the preceding example, the replay data write circuitry 320 writes the first portion of the compressed frame data, such as compressed pixel data, allocated for caching to the system cache 130, and writes the remaining second portion of the compressed frame data, such as compressed pixel data, to the replay buffer 140 reserved in the system memory 125. In some examples, the replay data write circuitry 320 utilizes the tag(s) assigned to the different portions (e.g., cache lines) of the compressed frame data, such as compressed pixel data, to determine whether to write the different portions (e.g., cache lines) of the data to the system cache 130 or the replay buffer 140 reserved in the system memory 125.

In some examples, the replay data write circuitry 320 implements write-through caching with the system cache 130. In such examples, the replay data write circuitry 320 writes compressed frame data, such as compressed pixel data, tagged for caching to both the system cache 130 and the replay buffer 140 reserved in the system memory 125. By implementing write-through caching, the replay data write circuitry 320 ensures a copy of the compressed frame data (e.g., the compressed pixel data) is available in the replay buffer 140 in case the compressed frame data (e.g., the compressed pixel data) is evicted from the cache (e.g., by a higher-priority agent).

The replay data read circuitry 325 of the illustrated example reads the compressed frame data, such as compressed pixel data, stored in the system cache 130, or stored in a combination of the system cache 130 the replay buffer 140 reserved in the system memory 125, for a preceding new frame. In other words, the replay data read circuitry 325 reads at least a portion of the compressed frame data, such as compressed pixel data, associated with the preceding new frame from the system cache 130 based on the amount of the system cache 130 allocated for display data buffering. In some examples, the replay data read circuitry 325 of the illustrated example reads the compressed frame data, such as compressed pixel data, from the system cache 130, or from a combination of the system cache 130 the replay buffer 140, based on a determination that a subsequent second frame after the preceding new frame is unchanged and, thus, no frame update has occurred for that subsequent frame. The absence of the frame update indicates that the content of the subsequent second frame is unchanged and, thus, the frame replay circuitry 105 can generate a replay frame for the second frame.

In some examples, the replay data read circuitry 325 utilizes the tag(s) assigned by the replay data tagging circuitry 315 to the different portions (e.g., cache lines) of the compressed frame data, such as compressed pixel data, to determine whether to read the different portions (e.g., cache lines) of the data from the system cache 130 or from the replay buffer 140 reserved in the system memory 125. Thus, in the preceding example, the replay data read circuitry 325 reads the first portion of the compressed frame data, such as compressed pixel data, from the system cache 130, and reads the remaining second portion of the compressed frame data, such as compressed pixel data, from the replay buffer 140 reserved in the system memory 125.

In some examples, the replay data read circuitry 325 includes the tags assigned by the replay data tagging circuitry 315 to the given portions (e.g., the given cache lines) of the compressed frame (e.g., pixel) data in the read requests for those given portions (e.g., those given cache lines) of the compressed frame (e.g., pixel) data. In some such examples, the tags serve as caching hints for the system cache 130. For example, the system cache 130 can intercept the read requests from the replay data read circuitry 325 and, for a given read requests, evaluate the tag included in the read request. If the tag indicates the requested data was allocated for storage in the system cache 130, the system cache 130 attempts to retrieve the data locally from the system cache 130. If the attempt is successful (e.g., corresponding to a cache hit), the system cache 130 returns the requested cached data. However, if the attempt is unsuccessful (e.g., corresponding to a cache miss, which may be the result of eviction of the requested data from the system cache 130), the system cache 130 forwards the request to the system memory 125 to enable the requested data to be retrieved from the replay buffer 140. In some examples, the requested data retrieved from the replay buffer 140 is also stored in the system cache 130 (e.g., if allocated space permits), thereby allowing for faster retrieval of the data for subsequent frames. In some examples, if the tag in a given read request intercepted by the system cache 130 indicates the requested data was not allocated to the system cache 130 (e.g., and was instead allocated to the replay buffer 140 reserved in the system memory 125), the system cache 130 forwards the request to the system memory 125 to enable the requested data to be retrieved from the replay buffer 140.

The replay frame generation circuitry 330 of the illustrated example uses the compressed frame data, such as compressed pixel data, read by the replay data read circuitry 325 from the system cache 130, or read from a combination of the system cache 130 the replay buffer 140 reserved in the system memory 125, to generate a replay frame to be used as a subsequent frame to be displayed by the display device 120. In other words, the replay frame generation circuitry 330 generates the replay frame based on at least the compressed frame data, such as compressed pixel data, read by the replay data read circuitry 325 from the system cache 130. In some examples, the replay frame generation circuitry 330 generates the replay frame based on a determination that a subsequent second frame after the preceding new frame associated with the data read from the system cache 130 (or read from a combination of the system cache 130 the replay buffer 140 reserved in the system memory 125) is unchanged and, thus, no frame update has occurred for that subsequent frame. As noted above, the absence of the frame update indicates that the content of the subsequent second frame is unchanged and, thus, the frame replay circuitry 105 can generate a replay frame for the second frame.

Thus, in the preceding example, the replay frame generation circuitry 330 generates the replay frame based on the first portion of the compressed frame data, such as compressed pixel data, read from the system cache 130, and the remaining second portion of the compressed frame data, such as compressed pixel data, read from the replay buffer 140 reserved in the system memory 125. In some examples, the replay frame generation circuitry 330 uncompresses the compressed data read from the system cache 130 (or read from a combination of the system cache 130 the replay buffer 140 reserved in the system memory 125) to generate the replay frame.

The display interface circuitry 335 of the illustrated example interfaces the frame replay circuitry 105 and, more generally, the display subsystem 115 with the display device 120 (see FIG. 1). For example, the display interface circuitry 335 can be implemented by any circuitry, connector(s), cable(s), pin(s), bus(ses), etc., capable of coupling the frame replay circuitry 105 and, more generally, the display subsystem 115 with the display device 120. In the illustrated example, the replay frame generation circuitry 330 of the frame replay circuitry 105 uses the display interface circuitry 335 to provide generated replay frame(s) to the display device 120 for presentation when the displayed frame content is idle (e.g., unchanged). In some examples, the frame data retrieval circuitry 305 also uses the display interface circuitry 335 to provide retrieved, new frames to the display device 120 for presentation when the displayed frame content is active (e.g., changing).

In the illustrated example, the frame replay circuitry 105 continues performing the above operations until the display device 120 and the display subsystem 115 is to stop displaying content. For example, the frame replay circuitry 105 continues performing the above operations until the display device 120 and/or the display subsystem 115 are powered OFF, enter a sleep state, etc. Furthermore, because the amount of the system cache 130 allocated for display data buffer is variable, the sizes of the portions of the compressed frame data (e.g., compressed pixel data) written to the system cache 130 and the replay buffer 140 reserved in the system memory 125 may change for subsequent new frames retrieved from the frame buffer 135 in the system memory.

In some examples, the compression circuitry 310 in the frame replay circuitry 105 can be omitted or bypassed such that the original, uncompressed frame data (e.g., the original, uncompressed pixel data) for a retrieved new frame is stored in the system cache 130 and/or the replay buffer 140. For example, the compression circuitry 310 may be omitted/bypassed if the size of the original, uncompressed frame data (e.g., the original, uncompressed pixel data) is small enough to fit in the system cache 130 without compression, or is small enough to fit in the combination of the system cache 130 and the replay buffer 140 without compression. Omitting/bypassing the compression circuitry 310 can reduce the complexity and power consumption associated with the display subsystem 115, and simply generation of subsequent replay frames as the cached/buffered frame data (e.g., pixel) data does not need to be uncompress. However, such a potential benefit may come at the potential expense of reducing the frequency and/or duration of the low power state(s) of the system memory 125 if, for example, the original, uncompressed frame data (e.g., the original, uncompressed pixel data) does not fit entirely with the system cache 130 and, thus, the replay buffer 140 is relied on to store at least some of the uncompressed data.

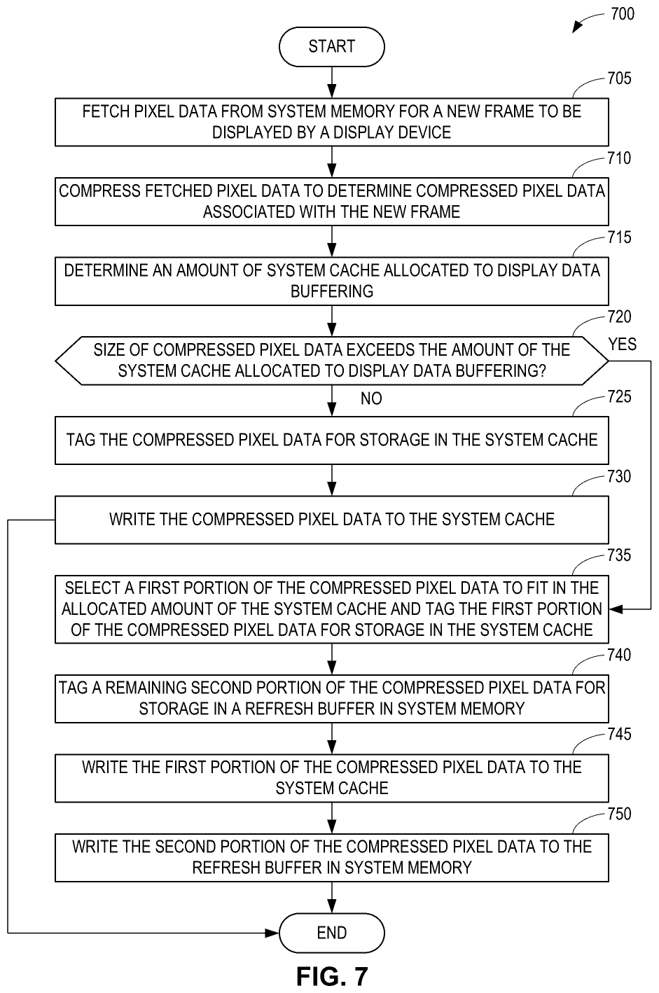

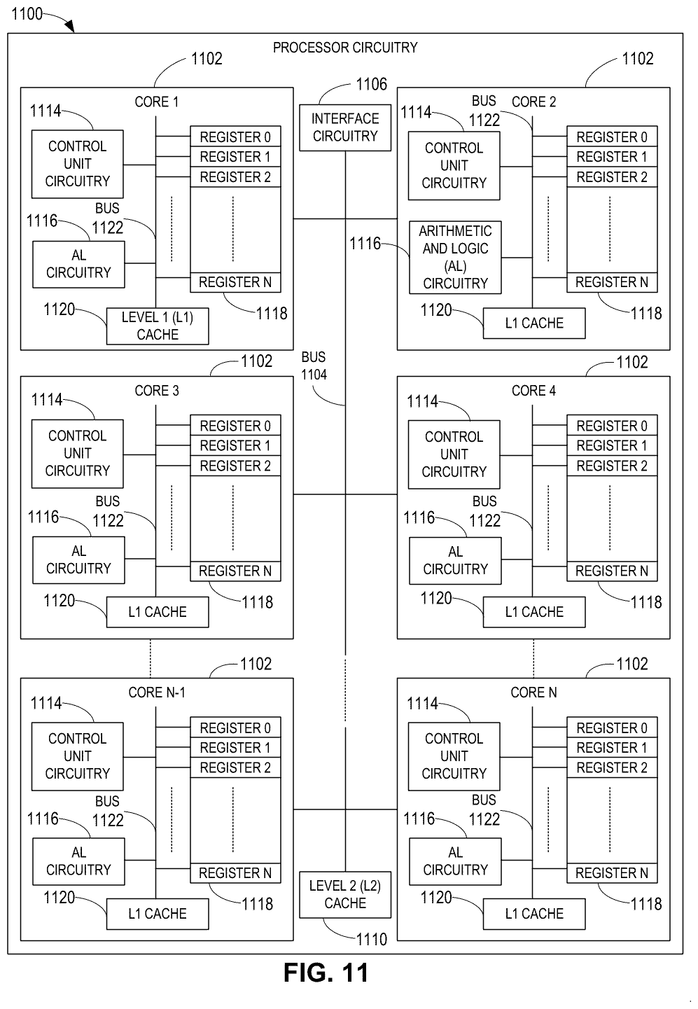

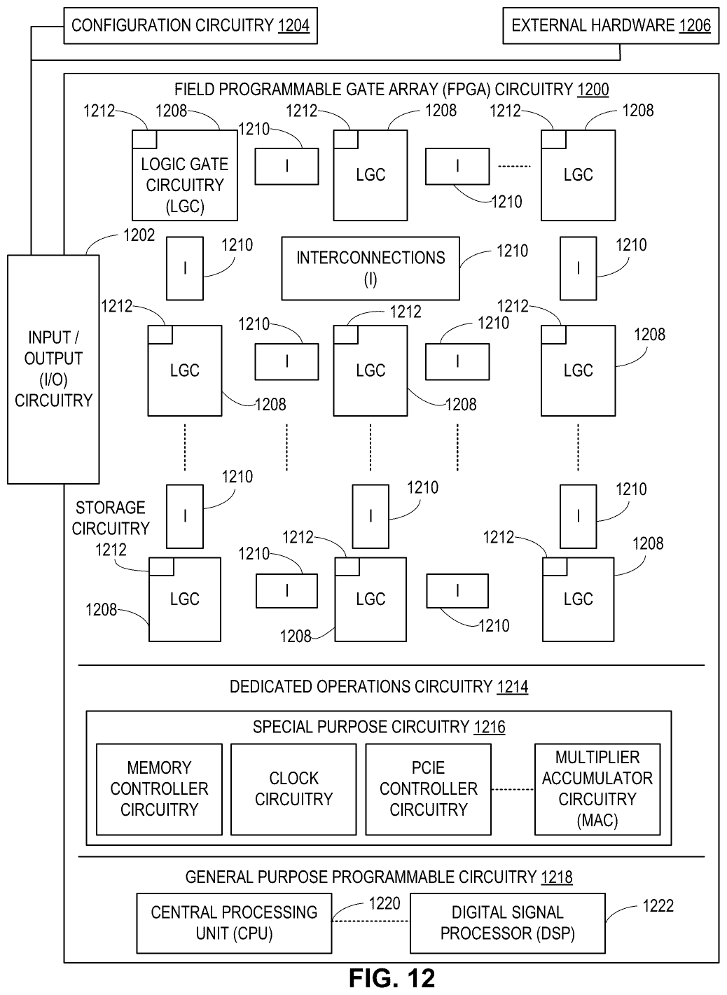

In some examples, the frame replay circuitry 105 includes means for retrieving new frame data. For example, the means for retrieving new frame data may be implemented by the frame data retrieval circuitry 305. In some examples, the frame data retrieval circuitry 305 may be instantiated by programmable circuitry such as the example programmable circuitry 1012 of FIG. 10. For instance, the frame data retrieval circuitry 305 may be instantiated by the example microprocessor 1100 of FIG. 11 executing machine executable instructions such as those implemented by at least block 705 of FIG. 7. In some examples, the frame data retrieval circuitry 305 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the frame data retrieval circuitry 305 may be instantiated by any other combination of hardware, software, and/or firmware. For example, the frame data retrieval circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the frame replay circuitry 105 includes means for compressing data. For example, the means for compressing data may be implemented by the compression circuitry 310. In some examples, the compression circuitry 310 may be instantiated by programmable circuitry such as the example programmable circuitry 1012 of FIG. 10. For instance, the compression circuitry 310 may be instantiated by the example microprocessor 1100 of FIG. 11 executing machine executable instructions such as those implemented by at least block 710 of FIG. 7. In some examples, the compression circuitry 310 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the compression circuitry 310 may be instantiated by any other combination of hardware, software, and/or firmware. For example, the compression circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the frame replay circuitry 105 includes means for tagging pixel data for storage. For example, the means for tagging pixel data for storage may be implemented by the replay data tagging circuitry 315. In some examples, the replay data tagging circuitry 315 may be instantiated by programmable circuitry such as the example programmable circuitry 1012 of FIG. 10. For instance, the replay data tagging circuitry 315 may be instantiated by the example microprocessor 1100 of FIG. 11 executing machine executable instructions such as those implemented by at least blocks 715-725, 735, 740 of FIG. 7. In some examples, the replay data tagging circuitry 315 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the replay data tagging circuitry 315 may be instantiated by any other combination of hardware, software, and/or firmware. For example, the replay data tagging circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the frame replay circuitry 105 includes means for writing pixel data to storage. For example, the means for writing pixel data to storage may be implemented by the replay data write circuitry 320. In some examples, the replay data write circuitry 320 may be instantiated by programmable circuitry such as the example programmable circuitry 1012 of FIG. 10. For instance, the replay data write circuitry 320 may be instantiated by the example microprocessor 1100 of FIG. 11 executing machine executable instructions such as those implemented by at least blocks 730, 745, 750 of FIG. 7. In some examples, the replay data write circuitry 320 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the replay data write circuitry 320 may be instantiated by any other combination of hardware, software, and/or firmware. For example, the replay data write circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

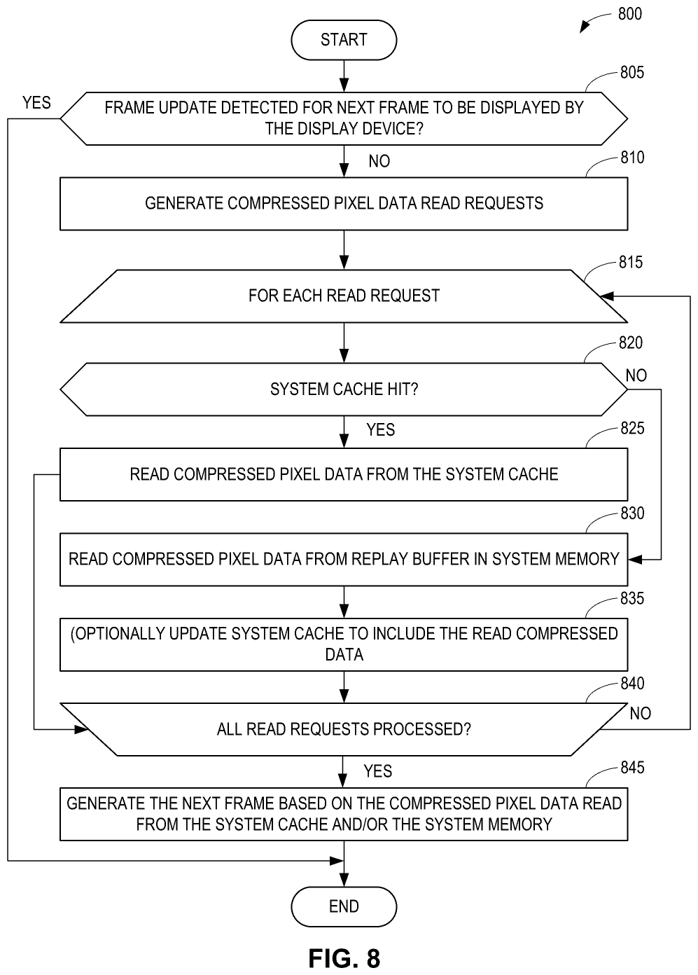

In some examples, the frame replay circuitry 105 includes means for reading pixel data from storage. For example, the means for reading pixel data from storage may be implemented by the replay data read circuitry 325. In some examples, the replay data read circuitry 325 may be instantiated by programmable circuitry such as the example programmable circuitry 1012 of FIG. 10. For instance, the replay data read circuitry 325 may be instantiated by the example microprocessor 1100 of FIG. 11 executing machine executable instructions such as those implemented by at least blocks 805-840 of FIG. 8. In some examples, the replay data read circuitry 325 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the replay data read circuitry 325 may be instantiated by any other combination of hardware, software, and/or firmware. For example, the replay data read circuitry 325 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the frame replay circuitry 105 includes means for generating replay frames. For example, the means for generating replay frames may be implemented by the replay frame generation circuitry 330. In some examples, the replay frame generation circuitry 330 may be instantiated by programmable circuitry such as the example programmable circuitry 1012 of FIG. 10. For instance, the replay frame generation circuitry 330 may be instantiated by the example microprocessor 1100 of FIG. 11 executing machine executable instructions such as those implemented by at least block 845 of FIG. 8. In some examples, the replay frame generation circuitry 330 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the replay frame generation circuitry 330 may be instantiated by any other combination of hardware, software, and/or firmware. For example, the replay frame generation circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the frame replay circuitry 105 includes means for interfacing with a display device. For example, the means for interfacing with a display device may be implemented by the display interface circuitry 335. In some examples, the display interface circuitry 335 may be instantiated by programmable circuitry such as the example programmable circuitry 1012 of FIG. 10. For instance, the display interface circuitry 335 may be instantiated by the example microprocessor 1100 of FIG. 11 executing machine executable instructions. In some examples, the display interface circuitry 335 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the display interface circuitry 335 may be instantiated by any other combination of hardware, software, and/or firmware. For example, the display interface circuitry 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the frame replay circuitry 105 of FIG. 1 is illustrated in FIG. 3, one or more of the elements, processes, and/or devices illustrated in FIG. 3 may be combined, divided, re-arranged, omitted, eliminated, and/or implemented in any other way. Further, the example frame data retrieval circuitry 305, the example compression circuitry 310, the example replay data tagging circuitry 315, the example replay data write circuitry 320, the example replay data read circuitry 325, the example replay frame generation circuitry 330, the example display interface circuitry 335, and/or, more generally, the example frame replay circuitry 105 of FIG. 3, may be implemented by hardware alone or by hardware in combination with software and/or firmware. Thus, for example, any of the example frame data retrieval circuitry 305, the example compression circuitry 310, the example replay data tagging circuitry 315, the example replay data write circuitry 320, the example replay data read circuitry 325, the example replay frame generation circuitry 330, the example display interface circuitry 335, and/or, more generally, the example frame replay circuitry 105, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example frame replay circuitry 105 of FIG. 3 may include one or more elements, processes, and/or devices in addition to, or instead of, those illustrated in FIG. 3, and/or may include more than one of any or all of the illustrated elements, processes and devices.

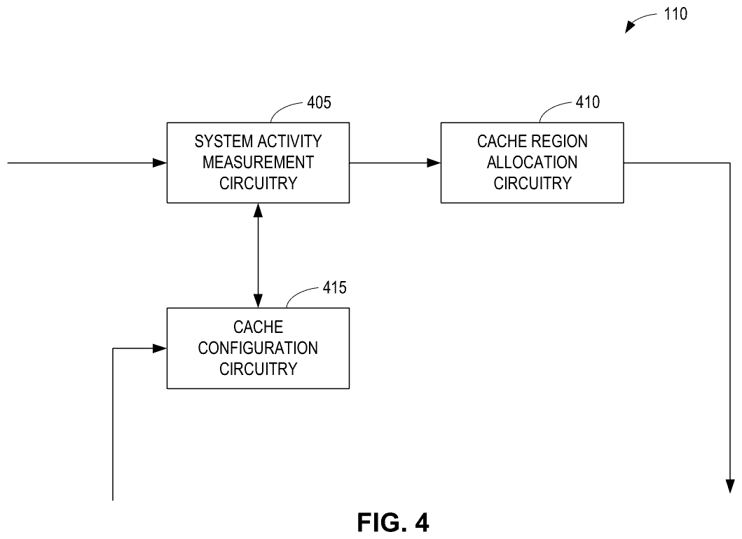

FIG. 4 is a block diagram of an example implementation of the cache management circuitry 110 of FIG. 1. The cache management circuitry 110 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the cache management circuitry 110 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example cache management circuitry 110 of FIG. 4 includes example system activity measurement circuitry 405, example cache region allocation circuitry 410 and example cache configuration circuitry 415. The system activity measurement circuitry 405 of the illustrated example measures activity states associated respectively with cache accessing agents that are capable of accessing the system cache 130 in the compute system 100 (see FIG. 1). In some examples, the cache management circuitry 110 monitors the cache accessing agents, as described above, to determine activity states associated respectively with the cache accessing agents. For example, the activity state for a particular cache accessing agent may indicate whether the agent is active, idle, etc. The cache accessing agents monitored by the cache management circuitry 110 may include the display subsystem 115 and/or any other device, circuitry, application, etc., of the compute system 100. For example, the cache accessing agents may include one or more CPU cores, one or more network interface card (NICs), one or more accelerator circuits, etc.

The cache region allocation circuitry 410 of the illustrated example dynamically allocates an amount of the system cache 130 to display data buffering, also referred to as frame data buffering, pixel data buffering, display buffering, etc., associated with a display device. In some examples, the cache region allocation circuitry 410 determines the amount of the cache allocated to frame data buffering based on the activity states measured by the system activity measurement circuitry 405. In some examples, the cache region allocation circuitry 410 determines the amount of the system cache 130 allocated to frame data buffering based on cache usage estimates corresponding respectively to the measured activity states. For example, the cache usage estimates may be determined during post-silicon tuning of the compute system 100. Additionally or alternatively, in some examples, the cache region allocation circuitry 410 determines the amount of the system cache 130 allocated to frame data buffering based on the measured activity states and one or more machine learning models. For example, the machine learning models may be trained to predict cache utilization by the different cache allocation agents under different activity states.

The cache region allocation circuitry 410 also provides information to the display subsystem 115 (see FIG. 1) that specifies the amount of the system cache 130 allocated to frame data buffering. In some examples, the information provided by the cache region allocation circuitry 410 may specify the region of the system cache 130 allocated to display subsystem 115 for frame data buffering. For example, the information provided by the region allocation circuitry 410 may specify the start address and the end address of the cache allocated cache region, the start address and the size of the allocated cache region, etc.

As mentioned above, the cache management circuitry 110 dynamically allocates the system cache 130 for frame data buffering. In some examples, the cache management circuitry 110 may update the allocation of the system cache 130 for frame data buffering periodically at times referred to as cache allocation times, cache measurement times, cache agent monitoring times, etc. Additionally or alternatively, in some examples, the cache management circuitry 110 may update the allocation of the system cache 130 for frame data buffering based on one or more events, such as when the activity state(s) for one or more caching accessing agents change, etc.

For example, the cache region allocation circuitry 410 may allocate a first amount of the system cache 130 for frame data buffering based on activity states measured by the system activity measurement circuitry 405 at a first time. For example, the cache region allocation circuitry 410 may allocate a first amount of the system cache 130 for frame data buffering based on the activity states corresponding to a first level of system activity. The cache region allocation circuitry 410 may further provide first information to the display subsystem 115 that specifies the first amount of the system cache 130 allocated for frame data buffering at that first time. Then, the cache region allocation circuitry 410 may allocate a different second amount of the system cache 130 for frame data buffering based on activity states measured by the system activity measurement circuitry 405 at a later second time. The cache region allocation circuitry 410 may further provide second information to the display subsystem 115 that specifies the second amount of the system cache 130 allocated for frame data buffering at that second time. For example, the second amount may be greater than the first amount is the activity states measured at the second time correspond to a second level of system activity that is lower than the first level of system activity. Further details concerning operation of the cache region allocation circuitry 410 are provided below in the context of the description of FIGS. 5 and 6.

The cache configuration circuitry 415 of the illustrated example configures operation of the system cache 130. For example, the cache configuration circuitry 415 may configure one or more reserved regions of the system cache 130, one or more unreserved regions of the system cache 130, etc., based on system activity information provided by the system activity measurement circuitry 405. In some examples, the cache configuration circuitry 415 measures utilization of the system cache 130. In some such examples, the measured utilization of the system cache 130 can also be used by the cache region allocation circuitry 410 to allocate an amount of the system cache 130 for frame data buffering.

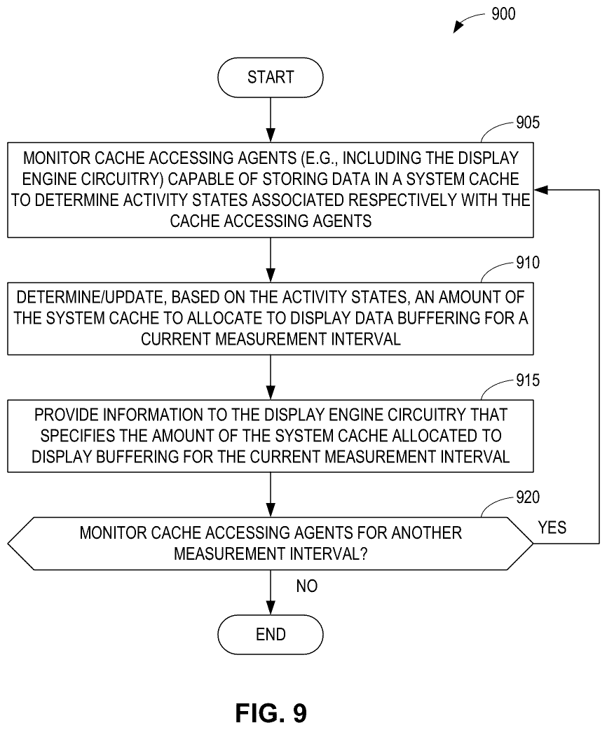

In some examples, the cache management circuitry 110 includes means for measuring system activity. For example, the means for measuring system activity may be implemented by the system activity measurement circuitry 405. In some examples, the system activity measurement circuitry 405 may be instantiated by programmable circuitry such as the example programmable circuitry 1012 of FIG. 10. For instance, the system activity measurement circuitry 405 may be instantiated by the example microprocessor 1100 of FIG. 11 executing machine executable instructions such as those implemented by at least blocks 905, 920 of FIG. 9. In some examples, the system activity measurement circuitry 405 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the system activity measurement circuitry 405 may be instantiated by any other combination of hardware, software, and/or firmware. For example, the system activity measurement circuitry 405 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the cache management circuitry 110 includes means for allocating cache regions. For example, the means for allocating cache regions may be implemented by the cache region allocation circuitry 410. In some examples, the cache region allocation circuitry 410 may be instantiated by programmable circuitry such as the example programmable circuitry 1012 of FIG. 10. For instance, the cache region allocation circuitry 410 may be instantiated by the example microprocessor 1100 of FIG. 11 executing machine executable instructions such as those implemented by at least blocks 910, 920 of FIG. 9. In some examples, the cache region allocation circuitry 410 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the cache region allocation circuitry 410 may be instantiated by any other combination of hardware, software, and/or firmware. For example, the cache region allocation circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the cache management circuitry 110 includes means for configuring a cache. For example, the means for configuring a cache may be implemented by the cache configuration circuitry 415. In some examples, the cache configuration circuitry 415 may be instantiated by programmable circuitry such as the example programmable circuitry 1012 of FIG. 10. For instance, the cache configuration circuitry 415 may be instantiated by the example microprocessor 1100 of FIG. 11 executing machine executable instructions. In some examples, the cache configuration circuitry 415 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the cache configuration circuitry 415 may be instantiated by any other combination of hardware, software, and/or firmware. For example, the cache configuration circuitry 415 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the cache management circuitry 110 of FIG. 1 is illustrated in FIG. 4, one or more of the elements, processes, and/or devices illustrated in FIG. 4 may be combined, divided, re-arranged, omitted, eliminated, and/or implemented in any other way. Further, the example system activity measurement circuitry 405, the example cache region allocation circuitry 410, the example cache configuration circuitry 415, and/or, more generally, the example cache management circuitry 110 of FIG. 4, may be implemented by hardware alone or by hardware in combination with software and/or firmware. Thus, for example, any of the example system activity measurement circuitry 405, the example cache region allocation circuitry 410, the example cache configuration circuitry 415, and/or, more generally, the example cache management circuitry 110, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example cache management circuitry 110 of FIG. 4 may include one or more elements, processes, and/or devices in addition to, or instead of, those illustrated in FIG. 4, and/or may include more than one of any or all of the illustrated elements, processes and devices.

FIGS. 5-6 illustrate example dynamic cache allocation and associated display pixel caching scenarios supported by the frame replay circuitry 105 (see FIGS. 1 and/or 3) and the cache management circuitry 110 (see FIGS. 1 and/or 4). FIG. 5 illustrates a first example scenario 500 in which the cache management circuitry 110 allocates, at a first time, a first example region 505 of the system cache 130 for pixel data buffering. The cache management circuitry 110 also allocates a remaining second example region 510 of the system cache 130 for use by other cache accessing agents.

FIG. 5 also illustrates first example compressed pixel data 515 associated with a first new frame corresponding to the first time. The frame replay circuitry 105 selects an example first portion 520 of the compressed pixel data 515 such that the first portion 520 fits in the first region of the 505 of the system cache 130. In the illustrated examples, the frame replay circuitry 105 tags the first portion 520 of the compressed pixel data 515 as cacheable (e.g., by tagging the cache lines in the first portion 520 of the compressed pixel data 515 with a first tag that indicates those cache lines are cacheable). The frame replay circuitry 105 also identifies a remaining example second portion 525 of the compressed pixel data 515 as uncacheable (e.g., by tagging the cache lines in the second portion 525 of the compressed pixel data 515 with a second tag that indicates those cache lines are cacheable). The frame replay circuitry 105 then writes the first portion 520 of the compressed pixel data 515 to the system cache 130, and writes the second portion 525 of the compressed pixel data 515 to the replay buffer 140 reserved in the system memory 125.

FIG. 6 illustrates a second example scenario 600 in which the cache management circuitry 110 allocates, at a second time, a third example region 605 of the system cache 130 for pixel data buffering. The cache management circuitry 110 also allocates a remaining fourth example region 610 of the system cache 130 for use by other cache accessing agents. In the illustrated example of FIG. 6, the third region 605 of the system cache 130 allocated by the cache management circuitry 110 for pixel data buffering is larger than the first region 505 of the system cache 130 allocated at the first time (e.g., because the system activity measured at the second time is lower than the system activity measured at the second time).

FIG. 6 also illustrates second example compressed pixel data 615 associated with a second new frame corresponding to the second time. The frame replay circuitry 105 selects an example first portion 620 of the compressed pixel data 615 such that the first portion 620 fits in the third region of the 605 of the system cache 130. As can be seen in the illustrated example, the first portion 620 of the compressed pixel data 615 selected at the second time is larger than the first portion 520 of the compressed pixel data 515 selected at the first time. In the illustrated examples, the frame replay circuitry 105 tags the first portion 620 of the compressed pixel data 515 as cacheable (e.g., by tagging the cache lines in the first portion 620 of the compressed pixel data 615 with a first tag that indicates those cache lines are cacheable). The frame replay circuitry 105 also identifies a remaining example second portion 625 of the compressed pixel data 615 as uncacheable (e.g., by tagging the cache lines in the second portion 625 of the compressed pixel data 615 with a second tag that indicates those cache lines are cacheable). The frame replay circuitry 105 then writes the first portion 620 of the compressed pixel data 615 to the system cache 130, and writes the second portion 625 of the compressed pixel data 615 to the replay buffer 140 reserved in the system memory 125.

Flowchart(s) representative of example machine-readable instructions, which may be executed by programmable circuitry to implement and/or instantiate the frame replay circuitry 105 and the cache management circuitry 110 of FIGS. 3 and 4 and/or representative of example operations which may be performed by programmable circuitry to implement and/or instantiate the frame replay circuitry 105 and the cache management circuitry 110 of FIGS. 3 and 4, are shown in FIGS. 7-9. The machine-readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 7-9, many other methods of implementing the example frame replay circuitry 105 and the cache management circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 7-9 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 7 is a flowchart representative of example machine-readable instructions and/or example operations 700 that may be executed, instantiated, and/or performed by programmable circuitry to implement the frame replay circuitry 105 of FIG. 3. The example machine-readable instructions and/or the example operations 700 of FIG. 7 begin at block 705 at which the frame data retrieval circuitry 305 of the frame replay circuitry 105 fetches pixel data from the frame buffer 135 in the system memory 125 for a new frame to be displayed by the display device 120, as described above. At block 710, the compression circuitry 310 of the compresses fetched pixel data to determine compressed pixel data associated with the new frame, as described above. At block 715, the replay data tagging circuitry 315 of the frame replay circuitry 105 determines an amount of the system cache 130 that is allocated to display data buffering, as described above. At block 720, the replay data tagging circuitry 315 determines whether a size of the compressed pixel data determined at block 715 exceeds the amount of the system cache 130 that is allocated to display data buffering.

If the size of the compressed pixel data does not exceed the allocated amount of the system cache 130 (corresponding to the NO output of block 720), then at block 725 the replay data tagging circuitry 315 tags the compressed pixel data for storage in the system cache 130, as described above. At block 730, the replay data write circuitry 320 of the frame replay circuitry 105 writes the compressed pixel data to the system cache 130, as described above. The example machine-readable instructions and/or the example operations 700 then end.

However, if the size of the compressed pixel data does exceed the allocated amount of the system cache 130 (corresponding to the YES output of block 720), then at block 735 the replay data tagging circuitry 315 select a first portion of the compressed pixel data to fit in the allocated amount of the system cache 130, as described above. At block 735, the replay data tagging circuitry 315 also tags the first portion of the compressed pixel data for storage in the system cache 130. At block 740, the replay data tagging circuitry 315 tags a remaining second portion of the compressed pixel data for storage in the replay buffer 140 reserved in the system memory 125, as described above. At block 745, the replay data write circuitry 320 writes the first portion of the compressed pixel data to the system cache 130, as described above. At block 750, the replay data write circuitry 320 writes the second portion of the compressed pixel data to the replay buffer 140 in the system memory 125, as described above. The example machine-readable instructions and/or the example operations 700 then end.

FIG. 8 is a flowchart representative of example machine-readable instructions and/or example operations 700 that may be executed, instantiated, and/or performed by programmable circuitry to implement the frame replay circuitry 105 of FIG. 3. The example machine-readable instructions and/or the example operations 800 of FIG. 8 begin at block 805 at which the replay data read circuitry 325 of the frame replay circuitry 105 determines whether a frame update was detected for the next frame to be displayed by the display device 120, as described above. If a frame update is not detected for the next frame (corresponding to the NO output of block 805), at block 810 the replay data read circuitry 325 evaluates the tag(s) assigned to compressed pixel data associated with the most recent new frame displayed by the display device, as described above. At block 810, the replay data read circuitry 325 also generates read requests for the different portions (e.g., cache lines) of the compressed pixel data. At block 815, the replay data read circuitry 325 begins iterating through the read requests to obtain the compressed pixel data to be used to generate a next frame for display by the display device 120.

At block 820, if the current read request results in a cache hit (corresponding to the YES output at block 820), then at block 825, the replay data read circuitry 325 reads the compressed pixel data identified by the read request from the system cache 130, as described above. Otherwise (corresponding to the NO output of block 820), then at block 830 the replay data read circuitry 325 reads the compressed pixel data identified by the read request from the replay buffer 140 in the system memory 125, as described above. At block 835, the system cache 130 or the replay data read circuitry 325 optionally updates the system cache 130 to include the compressed pixel data read from the replay buffer 140 in the system memory 125, as described above. At block 840, the replay data read circuitry 325 continues iterating through the read requests until the complete compressed pixel data associated with the most recent new frame has been retrieved from the system cache 130 and/or the system memory 125.

At block 845, the replay frame generation circuitry 330 of the frame replay circuitry 105 generates the next frame based on the compressed pixel data read from the system cache 130 and/or the system memory 125. The example machine-readable instructions and/or the example operations 800 then end.

FIG. 9 is a flowchart representative of example machine-readable instructions and/or example operations 900 that may be executed, instantiated, and/or performed by programmable circuitry to implement the cache management circuitry 110 of FIG. 4. The example machine-readable instructions and/or the example operations 900 of FIG. 9 begin at block 905 at which the system activity measurement circuitry 405 of the cache management circuitry 110 monitors the cache accessing agents (e.g., including the display engine circuitry 115) capable of storing data in the system cache 130 to determine activity states associated respectively with the cache accessing agents, as described above. At block 910, the cache region allocation circuitry 410 of the cache management circuitry 110 determines/updates, based on the activity states, an amount of the system cache 130 to allocate to display data buffering for a current measurement interval (e.g., at a current measurement time, a current monitoring time, a current cache allocation time, etc.). At block 915, the cache region allocation circuitry 410 provides information to the display engine circuitry 115 that specifies the amount of the system cache 130 allocated to display buffering for the current measurement interval.

At block 920, the system activity measurement circuitry 405 determines whether monitoring of the cache accessing agents is to continue for another measurement interval. If monitoring is to continue (corresponding to the YES output of block 920), the processing returns to block 905 and blocks subsequent thereto. Otherwise (corresponding to the NO output of block 920), the example machine-readable instructions and/or the example operations 900 then end.

FIG. 10 is a block diagram of an example programmable circuitry platform 1000 structured to execute and/or instantiate the example machine-readable instructions and/or the example operations of FIGS. 7-9 to implement the frame replay circuitry 105 and the cache management circuitry 110 of FIGS. 3 and 4. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements the cache management circuitry 110.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016. In the illustrated example, the local memory 1013 implements the system cache 130. In the illustrated example, the main memory 1014 implements the system memory 125.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In the illustrated example, the interface circuitry 1020 implements the display subsystem 115, which includes the frame replay circuitry 105.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU. In the illustrated example, the output device(s) 1024 implement the display device 120.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIGS. 7-9, may be stored in the mass storage device 1028, in the volatile memory 1014, in the non-volatile memory 1016, and/or on at least one non-transitory computer-readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIGS. 3 and 4 as logic circuits to perform operations corresponding to those machine-readable instructions. In some such examples, the circuitry of FIGS. 3 and 4 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine-readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIGS. 7-9, and/or an ASIC may be configured and/or structured to perform third operation(s)/function(s) corresponding to a third portion of the machine-readable instructions represented by the flowcharts of FIGS. 7-9.

It should be understood that some or all of the circuitry of FIGS. 3 and 4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 3 and 4 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 3 and 4 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

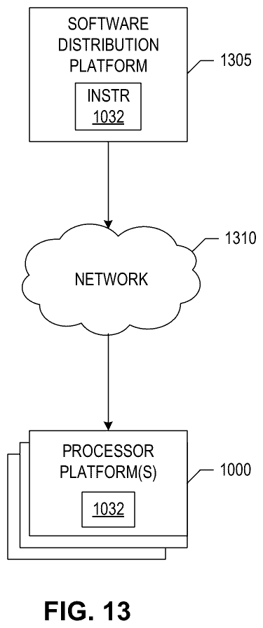

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1032 from the software distribution platform 1305. For example, the software, which may correspond to the example machine-readable instructions of FIGS. 7-9, may be downloaded to the example programmable circuitry platform 1000, which is to execute the machine-readable instructions 1032 to implement the frame replay circuitry 105 and the cache management circuitry 110. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement techniques to perform dynamic cache allocation for display pixel data caching. Disclosed systems, apparatus, articles of manufacture, and methods improve the efficiency of using a computing device by causing the device's display subsystem to write pixel data associated with a previously displayed frame to a system cache and use the cached pixel data to generate subsequent frames to be displayed by a display device when the displayed frame content is unchanged (e.g., when no frame updates have occurred for the subsequent frames). Such use of the system cache allows the display subsystem to limit system memory accesses to times at which new frames corresponding to frame updates are to be read from memory, which can substantially reduce the system memory bandwidth utilized by the display subsystem and allow the system memory to remain in a low power state for longer periods of times, thereby providing substantial power savings. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising memory to store frame data to be displayed by a display device, instructions, and at least one programmable circuit to be programmed based on the instructions to compress pixel data fetched from the memory to determine compressed pixel data associated with a first frame to be displayed by the display device, write at least a portion of the compressed pixel data to a cache based on an amount of the cache allocated to display buffering, the cache different from the memory, and generate a second frame based on the at least the portion of the compressed pixel data in the cache, the second frame to be displayed by the display device after the first frame.

Example 2 includes any preceding clause(s) of Example 1, wherein the amount of the cache allocated to display buffering is variable based on monitored system activity.

Example 3 includes any preceding clause(s) of any one or more of Examples 1-2, wherein one or more of the at least one programmable circuit is to obtain information that specifies the amount of the cache allocated to display buffering, the information to be obtained prior to writing the at least the portion of the compressed pixel data to the cache.

Example 4 includes any preceding clause(s) of any one or more of Examples 1-3, wherein the information is to define a region of the cache that is allocated to display buffering.

Example 5 includes any preceding clause(s) of any one or more of Examples 1-4, wherein one or more of the at least one programmable circuit is to determine the compressed pixel data associated with the first frame does not fit within the amount of the cache allocated to display buffering, select a first portion of the compressed pixel data to fit within the amount of the cache allocated to display buffering, write the first portion of the compressed pixel data to the cache and to a buffer in the memory, and write a remaining second portion of compressed to the buffer in the memory.

Example 6 includes any preceding clause(s) of any one or more of Examples 1-5, wherein one or more of the at least one programmable circuit is to assign a first tag to the first portion of the compressed pixel data, the first tag to indicate the first portion of the compressed pixel data is cacheable, and assign a second tag to the second portion of the compressed pixel data, the second tag to indicate the second portion of the compressed pixel data is not cacheable.

Example 7 includes any preceding clause(s) of any one or more of Examples 1-6, wherein one or more of the at least one programmable circuit is to read the first portion of the compressed pixel data from the cache based on the first tag assigned to the first portion of the compressed pixel data and the read of the first portion of the compressed pixel data corresponding to a cache hit, read the first portion of the compressed pixel data from the buffer in the memory based on the first tag assigned to the first portion of the compressed pixel data and the read of the first portion of the compressed pixel data corresponding to a cache miss, read the second portion of the compressed pixel data from the buffer in the memory based on the second tag assigned to the second portion of the compressed pixel data, and uncompress the first portion of the compressed pixel data and the second portion of the compressed pixel data to generate the second frame.

Example 8 includes any preceding clause(s) of any one or more of Examples 1-7, wherein the pixel data is first pixel data, the compressed pixel data is first compressed pixel data, the amount of the cache is a first amount of the cache, and one or more of the at least one programmable circuit is to read second pixel data from the memory, the second pixel data associated with a third frame to be displayed by the display device, compress the second pixel data into second compressed pixel data associated with the third frame, access information that specifies a second amount of the cache allocated to display buffering at a time associated with the third frame, the second amount different from the first amount, select a first portion of the second compressed pixel data to fit in the second amount of the cache allocated to display buffering, write the first portion of the second compressed pixel data to the cache, and write a remaining second portion of the second compressed pixel data to a buffer in the memory.

Example 9 includes any preceding clause(s) of any one or more of Examples 1-8, wherein the pixel data is first pixel data, the compressed pixel data is first compressed pixel data, the amount of the cache is a first amount of the cache, and one or more of the at least one programmable circuit is to read the first portion of the second compressed pixel data from the cache, read the second portion of the compressed pixel data from the buffer in the memory, and uncompress the first portion of the second compressed pixel data and the second portion of the compressed pixel data to generate a fourth frame to be displayed by the display device after the third frame.

Example 10 includes any preceding clause(s) of any one or more of Examples 1-9, wherein one or more of the at least one programmable circuit is to generate the second frame based on the at least the portion of the compressed pixel data in the cache after a determination that no frame update occurred between the first frame and the second frame.

Example 11 includes at least one non-transitory machine-readable medium comprising instructions to cause at least one programmable circuit to at least dynamically allocate an amount of a cache to buffering frame data associated with a display device, and provide, to display engine circuitry, information that specifies the amount of the cache allocated to buffering frame data, the display engine circuitry to provide frames to the display device.

Example 12 includes any preceding clause(s) of Example 11, wherein the instructions are to cause one or more of the at least one programmable circuit to monitor a plurality of cache accessing agents to determine activity states respectively associated with the cache accessing agents, and determine the amount of the cache allocated to buffering frame data based on the activity states.

Example 13 includes any preceding clause(s) of any one or more of Examples 11-12, wherein the cache accessing agents include the display engine circuitry.

Example 14 includes any preceding clause(s) of any one or more of Examples 11-13, wherein the instructions are to cause one or more of the at least one programmable circuit to determine the amount of the cache allocated to buffering frame data based on cache usage estimates corresponding respectively to the activity states.

Example 15 includes any preceding clause(s) of any one or more of Examples 11-14, wherein the instructions are to cause one or more of the at least one programmable circuit to determine the amount of the cache allocated to buffering frame data based on the activity states and a machine learning model.

Example 16 includes any preceding clause(s) of any one or more of Examples 11-15, wherein the amount is a first amount associated with a first level of system activity, the information is first information, and the instructions are to cause one or more of the at least one programmable circuit to allocate a second amount of the cache to buffering frame data after detection of a second level of system activity, the second amount greater than the first amount, and the second level of system activity lower than the first level of system activity, and provide second information to the display engine circuitry after the first information, the second information to specify the second amount of the cache allocated to buffering frame data.

Example 17 includes a system comprising memory to store frame data to be displayed by a display device, a cache, first circuitry to compress first frame data fetched from the memory to determine first compressed frame data associated with a first frame to be displayed by the display device, write at least a portion of the first compressed frame data to the cache based on an amount of the cache allocated to frame data buffering, the cache different from the memory, and generate a second frame based on the at least the portion of the first compressed frame data in the cache, the second frame to be displayed by the display device after the first frame. instructions, and second circuitry to be programmed based on the instructions to determine, based on measured system activity, the amount of the cache allocated to buffering frame data.

Example 18 includes any preceding clause(s) of Example 17, wherein the second circuitry is to detect a decrease in the measured system activity, and increase the amount of the cache allocated to buffering frame data based on the decrease in the measured system activity.

Example 19 includes any preceding clause(s) of any one or more of Examples 17-18, wherein the second circuitry is to detect an increase in the measured system activity, and decrease the amount of the cache allocated to buffering frame data based on the increase in the measured system activity.

Example 20 includes any preceding clause(s) of any one or more of Examples 17-19, wherein the first circuitry is to determine the first compressed frame data associated with the first frame does not fit within the amount of the cache allocated to display buffering, select a first portion of the first compressed frame data to fit within the amount of the cache allocated to display buffering, write the first portion of the first compressed frame data to the cache and to a buffer in the memory, write a remaining second portion of the first compressed frame data to the buffer in the memory, read the first portion of the first compressed frame data from the cache, read the second portion of the first compressed frame data from the buffer in the memory, and uncompress the first portion of the first compressed frame data and the second portion of the first compressed frame data to generate the second frame.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
memory to store frame data to be displayed by a display device;
instructions; and
at least one programmable circuit to be programmed based on the instructions to:
compress pixel data fetched from the memory to determine compressed pixel data associated with a first frame to be displayed by the display device;
write at least a portion of the compressed pixel data to a cache based on an amount of the cache allocated to display buffering, the cache different from the memory; and
generate a second frame based on the at least the portion of the compressed pixel data in the cache, the second frame to be displayed by the display device after the first frame.

2. The apparatus of claim 1, wherein the amount of the cache allocated to display buffering is variable based on monitored system activity.

3. The apparatus of claim 2, wherein one or more of the at least one programmable circuit is to obtain information that specifies the amount of the cache allocated to display buffering, the information to be obtained prior to writing the at least the portion of the compressed pixel data to the cache.

4. The apparatus of claim 3, wherein the information is to define a region of the cache that is allocated to display buffering.

5. The apparatus of claim 1, wherein one or more of the at least one programmable circuit is to:
determine the compressed pixel data associated with the first frame does not fit within the amount of the cache allocated to display buffering;
select a first portion of the compressed pixel data to fit within the amount of the cache allocated to display buffering;
write the first portion of the compressed pixel data to the cache and to a buffer in the memory; and
write a remaining second portion of compressed to the buffer in the memory.

6. The apparatus of claim 5, wherein one or more of the at least one programmable circuit is to:
assign a first tag to the first portion of the compressed pixel data, the first tag to indicate the first portion of the compressed pixel data is cacheable; and
assign a second tag to the second portion of the compressed pixel data, the second tag to indicate the second portion of the compressed pixel data is not cacheable.

7. The apparatus of claim 6, wherein one or more of the at least one programmable circuit is to:
read the first portion of the compressed pixel data from the cache based on the first tag assigned to the first portion of the compressed pixel data and the read of the first portion of the compressed pixel data corresponding to a cache hit;
read the first portion of the compressed pixel data from the buffer in the memory based on the first tag assigned to the first portion of the compressed pixel data and the read of the first portion of the compressed pixel data corresponding to a cache miss;
read the second portion of the compressed pixel data from the buffer in the memory based on the second tag assigned to the second portion of the compressed pixel data; and
uncompress the first portion of the compressed pixel data and the second portion of the compressed pixel data to generate the second frame.

8. The apparatus of claim 1, wherein the pixel data is first pixel data, the compressed pixel data is first compressed pixel data, the amount of the cache is a first amount of the cache, and one or more of the at least one programmable circuit is to:
read second pixel data from the memory, the second pixel data associated with a third frame to be displayed by the display device;
compress the second pixel data into second compressed pixel data associated with the third frame;
access information that specifies a second amount of the cache allocated to display buffering at a time associated with the third frame, the second amount different from the first amount;
select a first portion of the second compressed pixel data to fit in the second amount of the cache allocated to display buffering;
write the first portion of the second compressed pixel data to the cache; and
write a remaining second portion of the second compressed pixel data to a buffer in the memory.

9. The apparatus of claim 8, wherein the pixel data is first pixel data, the compressed pixel data is first compressed pixel data, the amount of the cache is a first amount of the cache, and one or more of the at least one programmable circuit is to:
read the first portion of the second compressed pixel data from the cache;
read the second portion of the compressed pixel data from the buffer in the memory; and
uncompress the first portion of the second compressed pixel data and the second portion of the compressed pixel data to generate a fourth frame to be displayed by the display device after the third frame.

10. The apparatus of claim 1, wherein one or more of the at least one programmable circuit is to generate the second frame based on the at least the portion of the compressed pixel data in the cache after a determination that no frame update occurred between the first frame and the second frame.

11. At least one non-transitory machine-readable medium comprising instructions to cause at least one programmable circuit to at least:
dynamically allocate an amount of a cache to buffering frame data associated with a display device; and
provide, to display engine circuitry, information that specifies the amount of the cache allocated to buffering frame data, the display engine circuitry to provide frames to the display device.

12. The at least one non-transitory machine-readable medium of claim 11, wherein the instructions are to cause one or more of the at least one programmable circuit to:
monitor a plurality of cache accessing agents to determine activity states respectively associated with the cache accessing agents; and
determine the amount of the cache allocated to buffering frame data based on the activity states.

13. The at least one non-transitory machine-readable medium of claim 12, wherein the cache accessing agents include the display engine circuitry.

14. The at least one non-transitory machine-readable medium of claim 12, wherein the instructions are to cause one or more of the at least one programmable circuit to determine the amount of the cache allocated to buffering frame data based on cache usage estimates corresponding respectively to the activity states.

15. The at least one non-transitory machine-readable medium of claim 12, wherein the instructions are to cause one or more of the at least one programmable circuit to determine the amount of the cache allocated to buffering frame data based on the activity states and a machine learning model.

16. The at least one non-transitory machine-readable medium of claim 11, wherein the amount is a first amount associated with a first level of system activity, the information is first information, and the instructions are to cause one or more of the at least one programmable circuit to:
allocate a second amount of the cache to buffering frame data after detection of a second level of system activity, the second amount greater than the first amount, and the second level of system activity lower than the first level of system activity; and
provide second information to the display engine circuitry after the first information, the second information to specify the second amount of the cache allocated to buffering frame data.

17. A system comprising
memory to store frame data to be displayed by a display device;
a cache;
first circuitry to:
compress first frame data fetched from the memory to determine first compressed frame data associated with a first frame to be displayed by the display device;
write at least a portion of the first compressed frame data to the cache based on an amount of the cache allocated to frame data buffering, the cache different from the memory; and
generate a second frame based on the at least the portion of the first compressed frame data in the cache, the second frame to be displayed by the display device after the first frame.
instructions; and
second circuitry to be programmed based on the instructions to determine, based on measured system activity, the amount of the cache allocated to buffering frame data.

18. The system of claim 17, wherein the second circuitry is to:
detect a decrease in the measured system activity; and
increase the amount of the cache allocated to buffering frame data based on the decrease in the measured system activity.

19. The system of claim 17, wherein the second circuitry is to:
detect an increase in the measured system activity; and
decrease the amount of the cache allocated to buffering frame data based on the increase in the measured system activity.

20. The system of claim 17, wherein the first circuitry is to:
determine the first compressed frame data associated with the first frame does not fit within the amount of the cache allocated to display buffering;
select a first portion of the first compressed frame data to fit within the amount of the cache allocated to display buffering;
write the first portion of the first compressed frame data to the cache and to a buffer in the memory;
write a remaining second portion of the first compressed frame data to the buffer in the memory;
read the first portion of the first compressed frame data from the cache;
read the second portion of the first compressed frame data from the buffer in the memory; and
uncompress the first portion of the first compressed frame data and the second portion of the first compressed frame data to generate the second frame.
